(19) United States
(12) Patent Application Publication
(10) Pub. No.: US 2010/0041266 A1
(43) Pub. Date: Feb. 18, 2010

(54) POWER CONNECTOR WITH INTEGRATED SIGNAL CONNECTOR

(76) Inventors: Mark M. Data, Bolingbrook, IL (US); Yan Margulis, Buffalo Grove, IL (US)

Correspondence Address: Molex, Inc, 2222 Wellington Court, Lisle, IL, 60532, US

(21) Appl. No.: 12/192,307

(22) Filed: Aug. 15, 2008

(51) Int. Cl. H01R 13/627; H01R 9/22; H01R 43/04

(52) U.S. Cl. 439/358; 439/717; 29/881

(57) ABSTRACT

A connector is provided that is suitable for connection to another connector. The connector can be a plug connector or a receptacle connector. The connector has a power contact and a signal contact. The signal contact may be provided by a modular housing that can be inserted into the connector housing. The signal contact can be wired separately into the modular housing and then the modular housing can be is inserted into the connector housing. A terminal position assurance member can then be used to secure the modular housing and power contact. An assembly of both the plug connector and the receptacle connector can be provided.

### BACKGROUND OF THE INVENTION

The present invention generally relates to combined electrical power and signal connectors that are integrated into a connector system and that can provide excellent operation under high current density conditions.

In general, connectors are suitable for use as modular components within modular assemblies. For example, modular assemblies can take, for example, the form of wire-to-board or wire-to-wire connectors and can, when desired, provide a low-profile connector system.

In previous prior art approaches, connectors have been made with one housing containing power and signal connectors, separate independent housings for power and signal connectors, separate terminal position assurance devices for signal and power contacts, and non-locking latches requiring minimal force to disengage. While existing connectors have provided acceptable, certain aspects of existing designs make the manufacture of such connectors more costly or difficult than desired. Furthermore, systems and methods of improving the reliability or ease of assembly would be appreciated. Accordingly, improvements in the design and construction of a connector would be appreciated by certain individuals.

### SUMMARY OF THE INVENTION

A connector assembly may be provided that includes a plug connector and a receptacle connector. The connector assembly includes one or more blade-type power contacts on the plug connector and multiple-pronged power contacts on the receptacle connector. The plug connector includes signal pin contacts mounted within a shrouded area of the module. The receptacle connector may include a signal module that is slidably mateable with the receptacle connector. When the plug connector and receptacle connector are joined, signal contacts in the signal module couple to signal pin contacts in the plug connector. In addition, power contacts on the plug connector engage power contacts the receptacle connector. Thus, the connector allows power and signals to be coupled together with a single connector assembly. If desired, a terminal position assurance member may be used to help secure the signal module and the power contact in place.

In an embodiment, a connector assembly can provide a receptacle module with a separate signal contact housing integrated with the power contact housing. The generally smaller signal wires are attached to the signal contacts in a separate signal housing and then the signal housing is seated within the power housing.

In another embodiment, a connector assembly suitably can provide a common terminal position assurance member. The receptacle power housing has apertures in a side wall that receive a locking rib of a terminal position assurance member that engages the power contacts. The terminal position assurance member may further include latched members that engage the signal housing and also lock onto the power housing.

In another embodiment, an enhanced latch may be employed on the receptacle connector. The latch may have support ribs providing additional strength to the latches. This provides for increased latch forces to disengage the receptacle connector, thereby improving the security of the mating connection.

### BRIEF DESCRIPTION OF THE DRAWINGS

FIG. 1 is an axonometric view of an embodiment of a mated wire-to-board connector assembly where the plug connector connects to a board members and the receptacle connector functions to provide wire connections;

FIG. 2 is an axonometric view of an embodiment of a plug connector suitable for inclusion within the connector assembly of FIG. 1;

FIG. 2A is an axonometric view of a plug contact component suitable for use within the plug connector of FIG. 2;

FIG. 2B is an exploded axonometric view of the plug contact component of FIG. 2A;

FIG. 3 is a top plan view of the plug connector of FIG. 2;

FIG. 4 is a front elevation view of the plug connector of FIG. 2;

FIG. 5 is a back elevation view of an embodiment of a plug connector comprising a group of housings joined together;

FIG. 5A is a front axonometric view of an end power component of a plug connector assembly embodiment such as in FIG. 5;

FIG. 5B is an elevation view of a middle signal component for the plug connector assembly of FIG. 5;

FIG. 5C is a rear axonometric view of the middle signal component for the assembly of FIG. 5;

FIG. 5D is a front axonometric view of another end power component for the plug connector assembly of FIG. 5;

FIG. 6 is an axonometric view of an embodiment of a receptacle connector suitable for inclusion within the connector assembly of FIG. 1;

FIG. 7 is another axonometric view of the receptacle connector of FIG. 6;

FIG. 8 is a top plan view of the receptacle connector of FIG. 6;

FIG. 9 is a cut-away axonometric view of the receptacle connector of FIG. 6;

FIG. 10 is a further cut-away axonometric view of the receptacle connector of FIG. 6;

FIG. 10A is an axonometric view of a receptacle power blade suitable for use within the receptacle connector of FIG. 6;

FIG. 11 is an axonometric view of a portion of the receptacle connector of FIG. 6;

FIG. 12 is an elevation view of an embodiment of a receptacle signal housing positioned within a receptacle connector housing;

FIG. 12A is an axonometric view of another embodiment of a receptacle signal housing suitable for use in an assembly such as in FIG. 12;

FIG. 13 is an axonometric view of an embodiment of a terminal position assurance member;

FIG. 14 is an axonometric view of an embodiment of a wire-to-wire connector assembly, shown in an unmated condition;

FIG. 14A is an axonometric view of an embodiment of a power connector with integrated signal connector, same being a plug connector where the plug connector functions to provide wire connections;

FIG. 15 is an axonometric view of an embodiment of a wire-to-board connector assembly, in an unmated condition, where the plug connector functions to provide wire connections, and the receptacle connector connects to a board member;

FIG. 15A is an axonometric view of an embodiment of a power connector with integrated signal connector, same being a plug connector where the plug connector connects to a board member;

FIG. 16 is a front elevation view of the receptacle connector of FIG. 15;

FIG. 17 is an axonometric view of an embodiment of a receptacle signal housing comprised of a stack of housings, each having a side-by-side row of signal contacts; and

FIG. 18 is an axonometric view of one of the housings of FIG. 17 having a side-by-side row of signal contacts.

### DETAILED DESCRIPTION OF THE ILLUSTRATED EMBODIMENTS

As required, detailed embodiments of the present invention are disclosed herein; however, it is to be understood that the disclosed embodiments are merely exemplary of the invention, which may be embodied in various forms. Therefore, specific details disclosed herein are not to be interpreted as limiting, but merely as a basis for the claims and as a representative basis for teaching one skilled in the art to variously employ the present invention in virtually any appropriate manner, including employing various features disclosed herein in combinations that might not be explicitly disclosed herein.

One or more embodiments of the present disclosure can realize the benefit of providing separate power and signal housings that readily integrate into one common connector. Other benefits can include providing a common terminal position assurance member for both power and signal contacts. Another possible benefit is to provide a structure that strengthens latching on the connector for increasing the amount of force required to disengage the connector to achieve improved latching security.

One or more embodiments can provide proper alignment, mechanical connection and electrical connection, while providing a low profile connection, if desired, and that also can be easily adapted to accommodate various size circuitry for wire-to-board or wire-to-wire connection, for example. Another benefit is enhanced wire management by allowing dense signal wiring, when desired for particular applications, to be assembled away from obstructions of the power wiring and/or of the power housing components, which pre-assembled signal wiring housing can then be readily properly and securely located in a connector with integrated signal and power contacts.

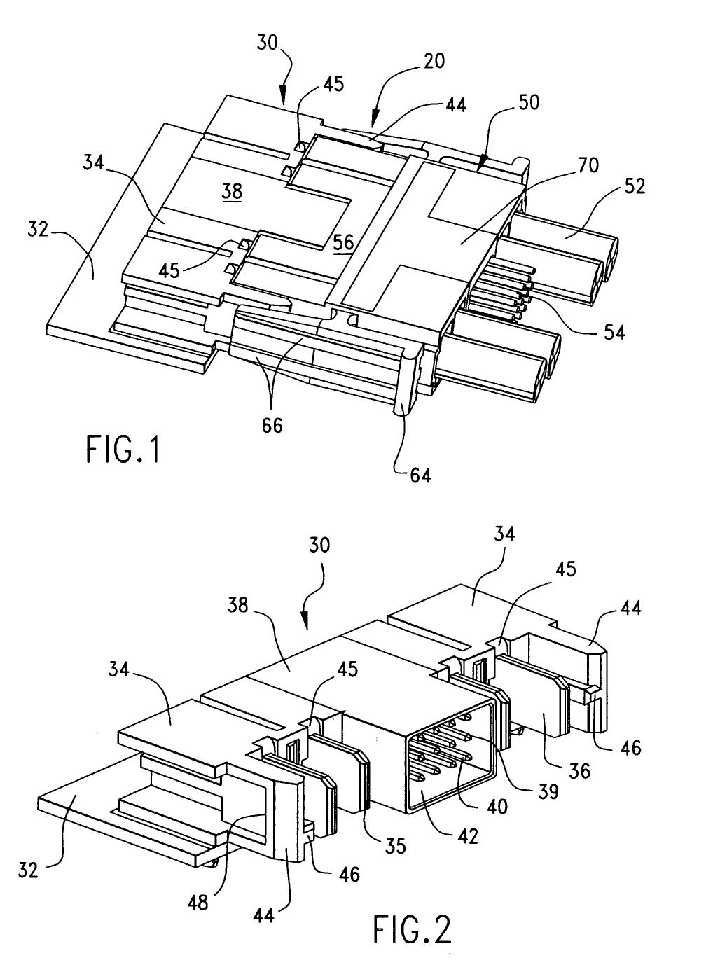

FIG. 1 illustrates an embodiment of a wire-to-board connector assembly generally designated 20. Particular embodiments of a connector assembly are disclosed in detail in the description and drawings of co-pending applications of the present assignee, U.S. application Ser. No. 11/999,068 and U.S. application Ser. No. 11/999,069 hereby incorporated by reference hereinto. Particular incorporation by reference is made to plug and receptacle connector uncoupled power contacts and mating interface airflow channels shown and described therein. The wire-to-board connector assembly 20 has a plug connector 30 and a receptacle connector 50. The plug connector 30 is connected to a circuit board 32. The receptacle connector 50 is connected to power wires 52 and signal wires 54. Alternatively, the plug connector could be connected to power and signal wires and the receptacle connector could be connected to a circuit board as generally described hereinafter.

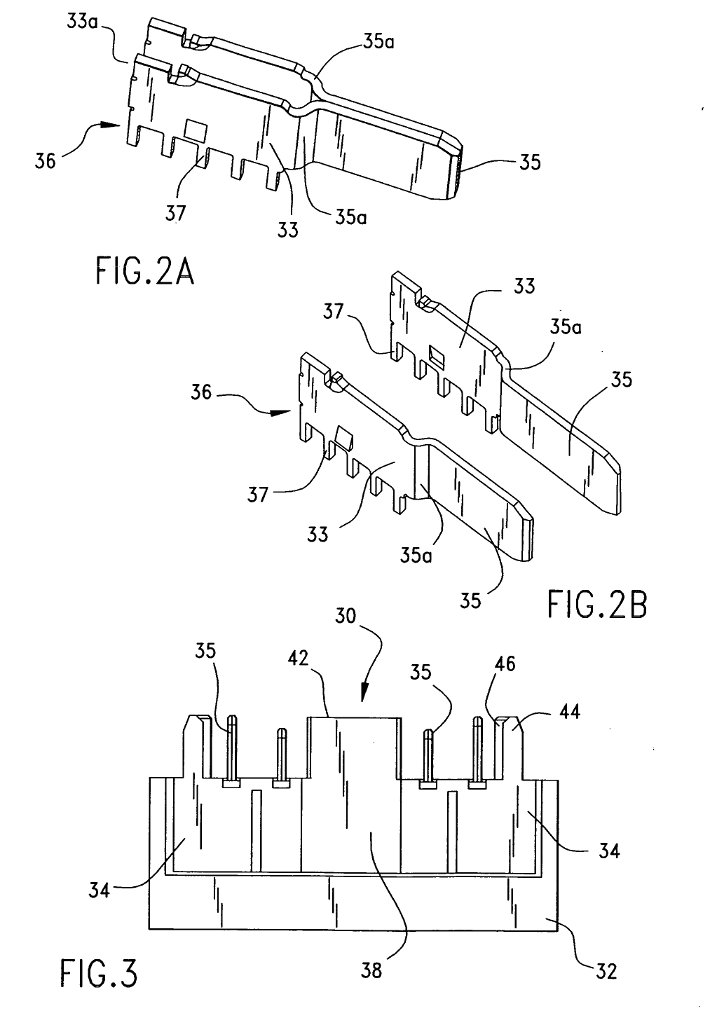

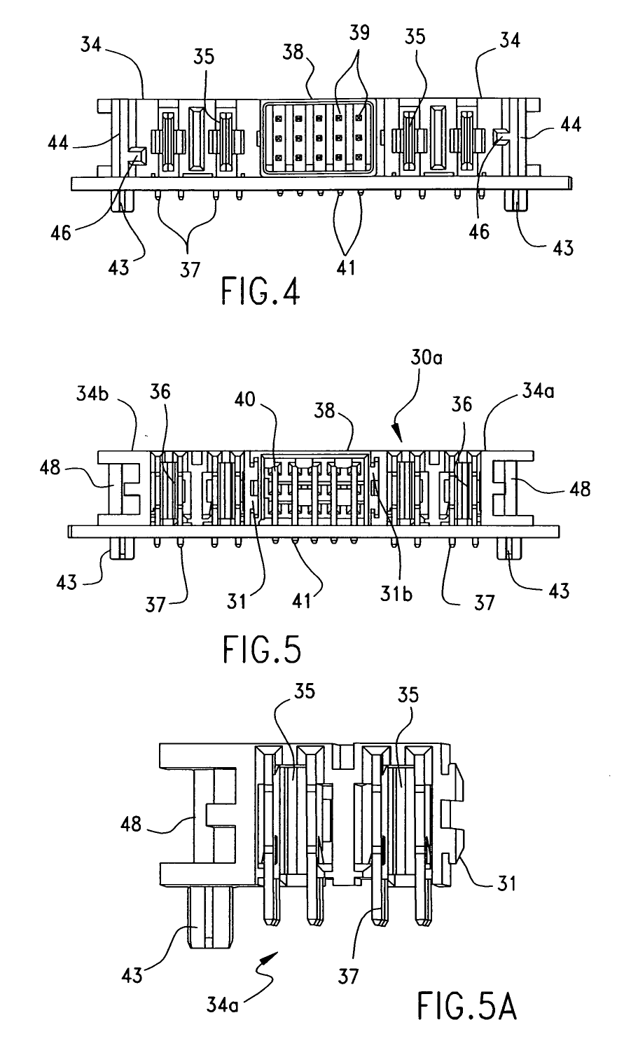

As illustrated in FIGS. 2 through 5, the plug connector 30 has a plug power housing 34 with plug power contacts 36. As shown in greater detail in FIG. 2A and FIG. 2B, the plug power contacts 36 have both plug power blades 35 and plug power tails 37 depending from back or body 33. A air of backs or bodies 33 are substantially parallel to each other and form a medial space 33a therebetween, forming uncoupled contacts. It will be seen that the spaced apart backs 33 are joined to the respective blade components 35 by a transition 35a first in an inward direction toward each other until they meet, and then parallel to each other into the blades 35. A plurality of the tails 37 extend from each back or body 33. It should be noted that the tails may extend in a manner that is orthogonal to blades 35 (as shown) or some other orientation such as parallel thereto (not shown).

The plug connector 30 further has plug signal housing area 38 with plug signal contacts 40. The plug signal contacts 40 have both plug signal pins 39 and plug signal tails 41. The plug power contacts 36 and the plug signal contacts 40 can be made of any industry standard conductive material such as metal. The plug power contacts 36 and plug signal contacts 40 of the illustrated embodiment are a copper alloy for example.

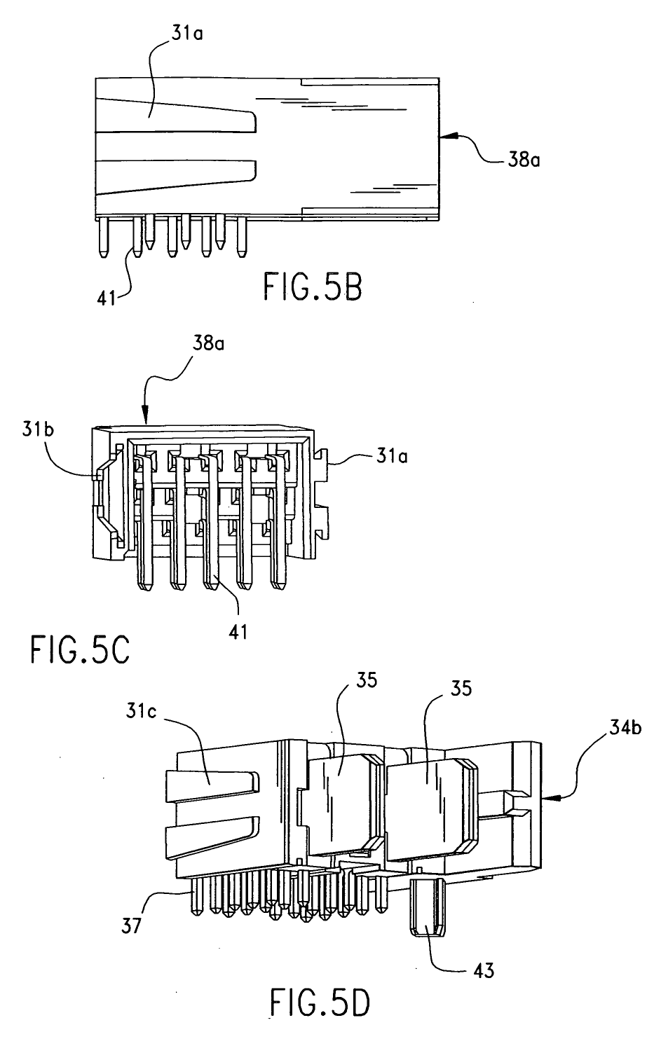

The plug power and signal connector 30a illustrated in FIGS. 5, 5A, 5B, 5C and 5D is comprised of multiple housings assembled together. Shown are end housings 34a and 34b and the plug signal housing 38a assembled into a signal and power unit. In the illustrated embodiment, the end housings 34a, 34b and middle housing 38a are mated together by dovetail joints, including dovetail members 31 and 31a, which can be configured as shown in FIGS. 5A, 5B, 5C and 5D. The plug power housings 34a, 34b and the plug signal housing 38 can be made of any industry standard dielectric material such as plastic. The plug power housings 34a, 34b and the plug signal housing 38 of the illustrated embodiment are high temperature polymer for example.

FIG. 5A shows an embodiment of an end power component within housing 34a and a dovetail member 31 at an inside wall of the housing 34a. A dovetail member 31a on an end wall of the middle housing 38a of FIG. 5B matingly engages the dovetail member 31. An opposing dovetail member 31b on an opposite end wall of the middle housing 38a (FIG. 5C) matingly engages a dovetail member 31c of inside end wall of end housing 34b shown in FIG. 5D. With these dovetail arrangements, the multiple housings 34a, 38a and 34b can be assembled together in modular fashion, giving the capability of switching between types or numbers of contacts within one or more of the housings.

In illustrated embodiments, airflow channels 45 are provided in the housing 34 of the plug connector 30, 30a. Each channel 45 is positioned adjacent a plug power contact 36 in order to allow some air flow and/or heat dissipation to reduce heat build up at the power contacts. Each channel typically is located at the interface between modules to facilitate access to locations potentially accessible to provide air flow, such interfaces being between housings, assemblies and/or modules.

The illustrated plug power tails 37 and plug signal tails 41 are solder tails. Alternatively, either or both of the plug power tails 37 and the plug signal tails 41 could be press-fit tails. A signal shroud 42 surrounds the plug signal contacts 40 to provide physical and electrical shielding. A guide blade 44 is positioned on each end of the plug connector 30, 30a to provide alignment with the receptacle connector 50. Each guide blade 44 can, as shown, have a keyed rib 46 to properly align the receptacle connector 50 and to insure correct polarization of the wire-to-board connector assembly 20. Each guide blade 44 can, as shown, also have a locking ledge 48 to receive a locking feature on the receptacle connector 50. The plug connector 30 can, as shown, also have mounting posts 43 for positioning and securing the plug connector 30, 30a to the circuit board 32.

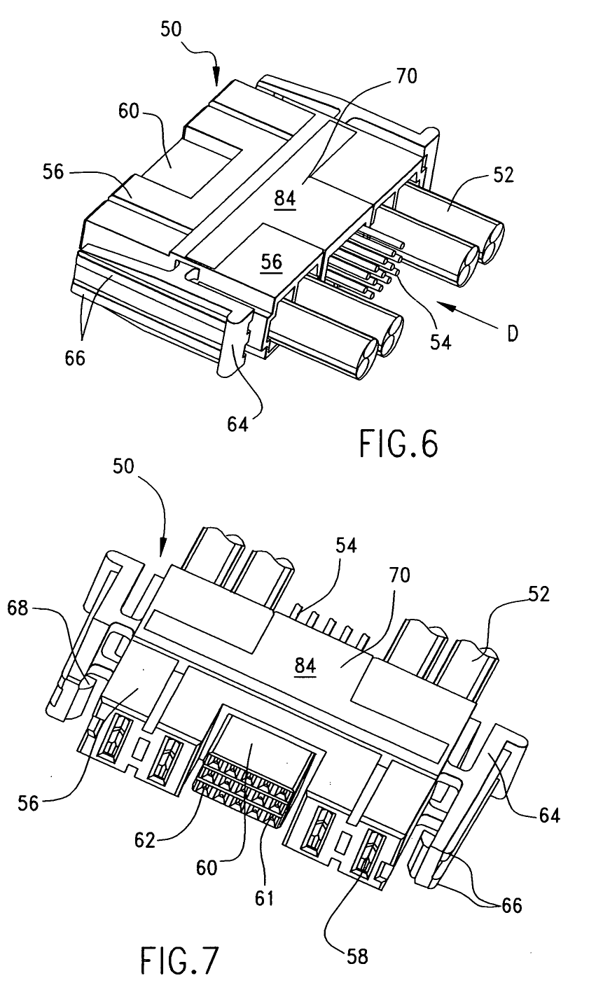

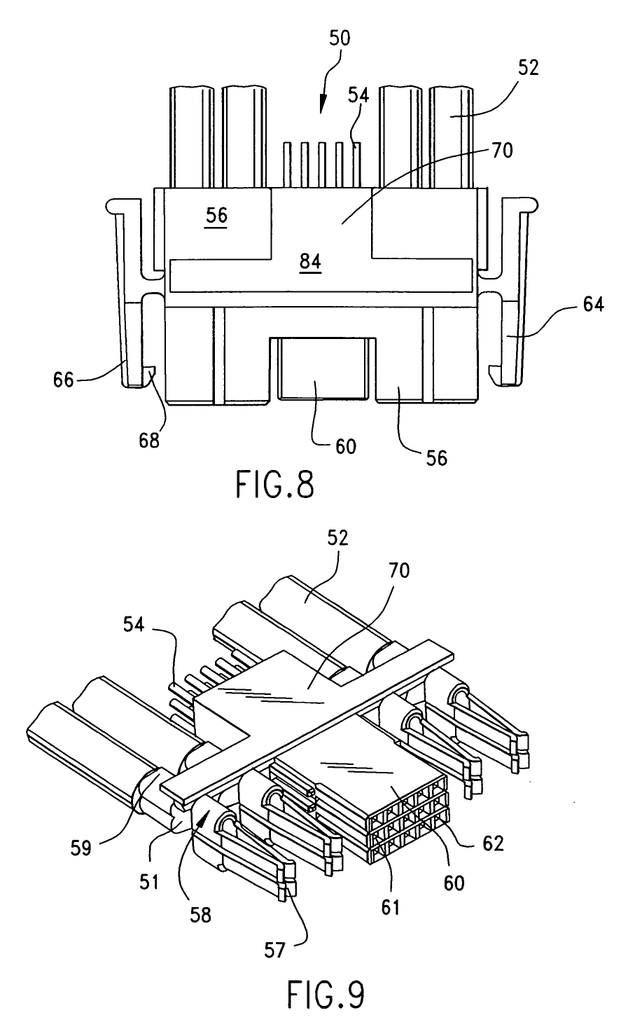

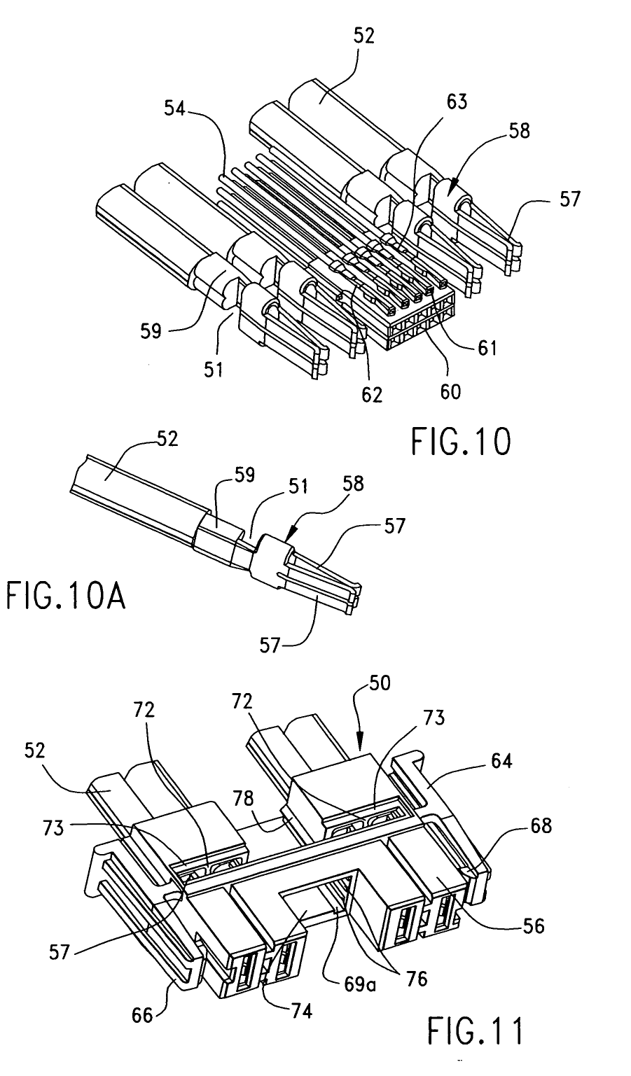

FIGS. 6 through 8 illustrate the receptacle connector 50 having a receptacle power housing 56 with receptacle power contacts, generally designated 58. The receptacle power contacts 58 have both receptacle power blades 57 and power crimp contacts 59 (FIG. 9). The receptacle connector 50 further has a receptacle signal housing 60 with receptacle signal contacts 62. The receptacle signal contacts 62 have both signal receptacles 61 and signal crimp contacts 63 (FIG. 10 and FIG. 10A). The receptacle power housing 56 and the receptacle signal housing 60 can be made of any industry standard dielectric material such as plastic. For example, the receptacle power housing 56 and the receptacle signal housing 60 of the illustrated embodiment can be a high temperature polymer. The receptacle power contacts 58 and the receptacle signal contacts 62 can be made of any industry standard conductive material such as metal, for example, the receptacle power contacts 58 and the receptacle signal contacts 62 of the illustrated embodiment can be a copper alloy.

The receptacle signal housing 60 is adapted to be received within the signal shroud 42 on the plug connector 30. The illustrated receptacle signal housing 60 is a single housing for all receptacle signal contacts 63. Alternatively, each row or column of receptacle signal contacts 63 could have a separate receptacle signal housing. A latch 64 can be provided on each end of the receptacle connector 50 and is adapted to engage the guide blades 44 on the plug connector 30, 30a. Alternatively, the guide blades could be on the receptacle connector and the guide channels could be on the plug connector as generally described hereinafter. The latch 64 can be, as shown, of a type that has support ribs 66 and a locking protrusion 68. The locking protrusion 68 is adapted to engage the locking ledge 48 on the plug connector 30.

A terminal position assurance member 70 is integrated into the receptacle power housing 56 wiring assembly of the connector assembly 20. The terminal position assurance member 70 is adapted to engage the receptacle power contacts 58 and the receptacle signal housing 60 (or housings as discussed herein). Such engagement holds the receptacle contacts (both power and signal) securely in place. This allows for handling of dense fine signal wires in their housing or housings by simple sliding or pass-through action without interference or space and/or positioning domination by the larger and less pliable power cables.

FIG. 9 illustrates the receptacle connector 50 with the receptacle power housing 56 removed. FIG. 10 illustrates the receptacle connector 50 of FIG. 9 with the terminal position assurance member 70 also removed and a portion of the receptacle signal housing 60 removed. The relatively small size of the receptacle signal contact 62 and the signal wire 54 can be appreciated in comparison to the illustrated receptacle power contacts 58 and power wires 52. FIG. 10A illustrates a receptacle power contact itself, shown crimped to power wire 52 at crimp location 59. A slot 51 provides an access location for receiving a projection of the terminal position assurance member 70 to assist in securing each receptacle power contact 58 at its proper position.

FIG. 11 illustrates the receptacle connector 50 with the receptacle signal housing 60 and the terminal position assurance member 70 removed. The receptacle power housing 56 has apertures 72 adapted to receive lock ribs 82 (FIG. 13) located on the terminal position assurance member 70. Recesses 73 accommodate the thickness of the member 70 when installed within the apertures 72. The receptacle power housing 56 further has a signal housing pass-through channel 74 adapted to slidably receive the receptacle signal housing 60, the insertion direction being illustrated at arrow “D” (FIG. 6).

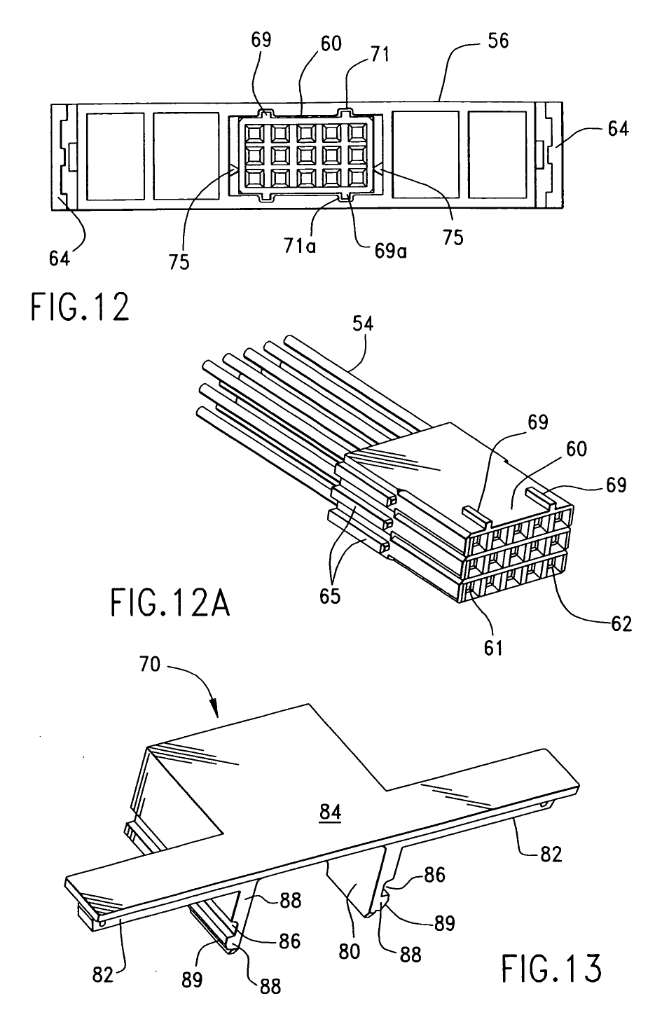

The receptacle signal housing 60 can have guide members 65 as seen in FIG. 12A. The guide members 65 are adapted to engage and be slidably received within guide channels 76 in the receptacle power housing 56 as seen in FIG. 11. The receptacle power housing 56 also has securing ledges 78. The receptacle housing 60 also can have projections 69 (FIGS. 12 and 12A) and projections 69a with complementary formations 70, 70a, which can be channels as shown in FIG. 12. Alternatively, the function of the projections can be carried out by indented formations (not shown), and the function of the channels can be carried out by projecting formations (not shown). Whatever formations are used they provide guidance during pass-through sliding of the receptacle signal housing 60 into the receptacle power housing 56. FIG. 12 also shows an alternative approach to the guide members 65 and guide channels 76. With this approach, there is no need to provide a member on the sidewall of the signal housing; instead, a stand-off 75 on an inside wall of the channel 74 engages the sidewall of the signal housing 60 during sliding and after insertion in order to provide good sliding characteristics and positive placement for the positive housing 60 assembled into the signal housing channel 74.

As further illustrated in FIG. 13, the terminal position assurance member 70 has latch members 80 that are deflectable to facilitate snap-in assembly to the housing 56 in the illustrated embodiment. In the illustrated arrangement, there are a pair of deflectable latch members 80, each being deflectable toward the other and biased toward an orientation generally perpendicular to outside surface 84 of the terminal position assurance member 70. When the terminal position assurance member is installed, as seen in FIG. 6 for example its outside surface 84 is generally parallel to and flush with the portions of the power housing 56 that are adjacent to the terminal position assurance member 70. Each latch member 80 has an indent 86 that engages and matingly accommodates a respective securing ledge 78 of the power housing when the terminal position assurance member 70 is placed in position such as on the receptacle housing 56 of the power connector 50. In this embodiment, each latch member 80 has a raised portion 88 immediately distal of the indent 86, and each raised portion has a tapered edge 89. During assembly of the terminal position assurance member 70 onto the power housing each latch member 80 moves into the aperture 72 until each latch member 80, typically at its tapered edge 89, engages the respective securing ledge 78, which also may be tapered complementary to the taper of the respective edge 89. In this illustrated embodiment, each tapered edge 89 of the raised portion 88 engages the respective securing ledge 78 of the power housing 50, the ledge 78 deflects the raised portion 88 and thus each latch member 80 until the securing ledge 78 enters the respective indent 86, at which time the flush relationship between the outside surface 84 and the outside surface of the power housing 56 is achieved.

When the terminal position assurance member 70 is placed in position on the receptacle power housing 56, the lock ribs 82 secure the receptacle power contacts 58 (see FIG. 9). In addition, when terminal position assurance member 70 is snapped into position, the latch members 80 secure the receptacle signal housing component 60 in place so as to be in alignment with corresponding signal plugs in this embodiment. As can be appreciated, therefore, the depicted “T” shape nature of the terminal position assurance member 70 allows for securing a power contact on both sides of the receptacle signal housing component 60. While the “T” shape is beneficial from a standpoint of allow forces to be distributed in a somewhat symmetric fashion, changes in the number and configuration of power contacts 58 may result in a different shape for the terminal position assurance member 70.

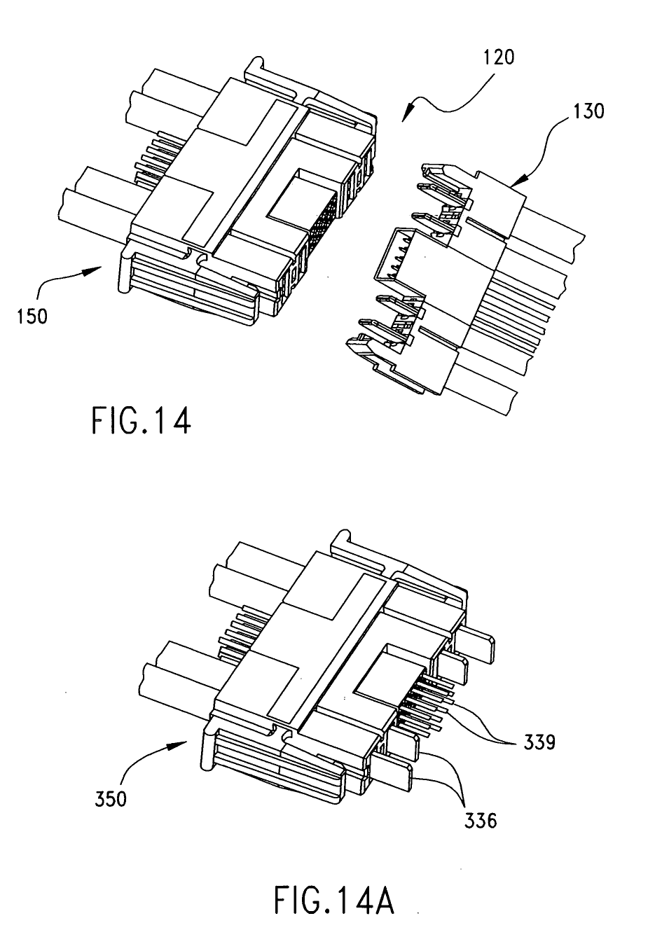

FIG. 14 illustrates an embodiment taking the form of a wire-to-wire connector assembly, generally designated 120. Plug connector 130 of the connector assembly 120 has wire leads, and same can have contacts and airflow channels therewithin as described in connection with the plug connector embodiment of FIG. 1 through FIG. 5. The contact receiving and mating components of receptacle connector 150 of the connector assembly 120 have wire leads, and same can be as described in connection with the receptacle connector embodiment of FIG. 1 and FIG. 6 through FIG. 11.

FIG. 14A illustrates an embodiment of a power connector with integrated signal connector module, taking the form of a plug connector 350. The plug connector 350 has wire leads, and same can be generally described in connection with the receptacle connector embodiment of FIG. 14 except that the receptacle power contacts are replaced by plug power contacts 336 and the receptacle signal contacts are replaced by plug signal contacts 339.

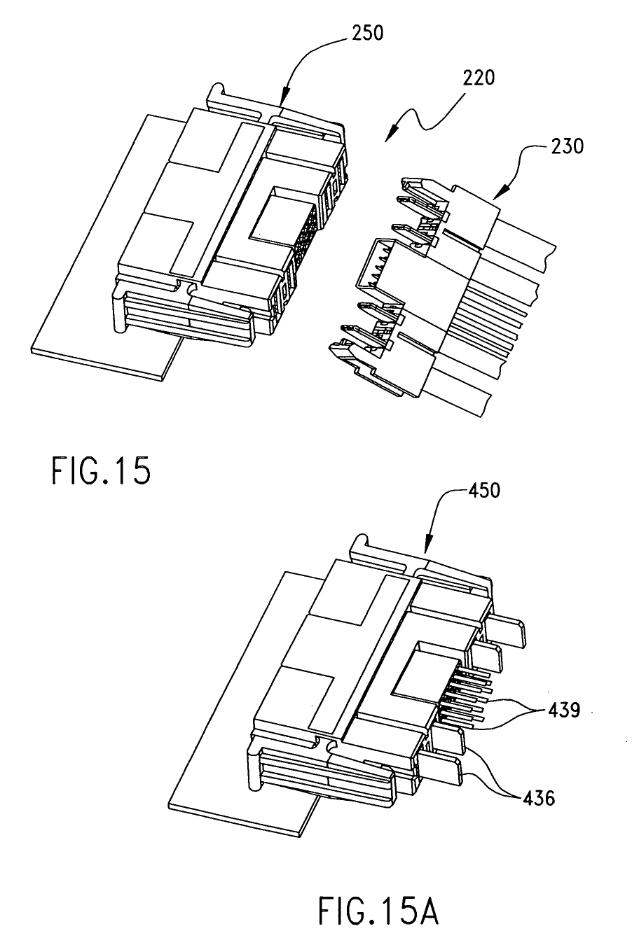

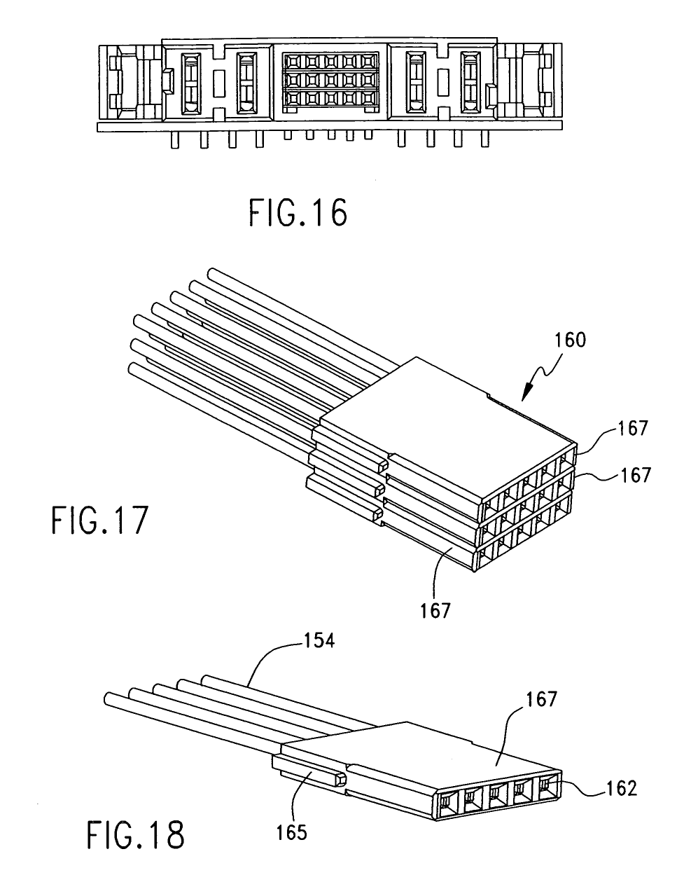

FIG. 15 and FIG. 16 illustrate an embodiment taking the form of an alternative wire-to-board connector assembly, generally designated 220. Plug connector 230 of the connector assembly 220 has wire leads, and same can have contacts and airflow channels therewithin as described in connection with the plug connector embodiment of FIG. 1 through FIG. 5. The contact receiving and mating components of receptacle connector 250 of the connector assembly 220 have contacts for boards and can be as described in connection with the receptacle connector embodiment of FIG. 1 and FIG. 6 through FIG. 11.

FIG. 15A illustrates an embodiment of a power connector with integrated signal connector module, taking the form of a plug connector 450. The power and signal contacts of plug connector 450 have contacts for boards, and same can be generally described in connection with the receptacle connector embodiment of FIG. 15 except that the receptacle power contacts are replaced by plug power contacts 436 and the receptacle signal contacts are replaced by plug signal contacts 439.

FIG. 17 shows a receptacle signal housing assembly, generally designated 160, comprised of a plurality of stacked receptacle signal modules 167, a single receptacle signal module being illustrated in FIG. 18. Each is sized and shaped to be accommodated within a suitable channel in a receptacle housing in order to provide pass-through characteristics. Each signal module 167 has a plurality of signal wires 154 in communication with respective receptacle signal contacts 162 within respective signal receptacles 161. In some arrangements, the signal module could be configured as a plug receptacle module (not shown), in which case a plurality of same provide a stacked plug signal module having pass-through capabilities.

It should be noted that in general, while plug connectors and receptacle receptors have been described as having certain features, the depiction of whether a connector is a plug or receptacle type in the figures is done merely for illustrative purposes. Therefore, it is envisioned that a particular connector could be configured to be a plug or a receptacle type or a combination of plug and receptacle, as desired. For example, a connector could include a power contact that is a plug type or a receptacle type and also include a signal contact that is a plug type or a receptacle type. Thus, for a connector with a single power contact and a single signal contact there are four possible variations with respect to plug versus receptacle. As the number of power contacts and signal contacts increase, the number of possible variations could also increase. Therefore, unless otherwise noted, the determination of whether a contact is a receptacle or plug is not intended to be limiting.

It will be understood that there are numerous modifications of the illustrated embodiments described above which will be readily apparent to one skilled in the art, such as many variations and modifications of the compression connector assembly and/or its components including combinations of features disclosed herein that are individually disclosed or claimed herein, explicitly including additional combinations of such features, or alternatively other types of contact array connectors. Also, there are many possible variations in the materials and configurations. These modifications and/or combinations fall within the art to which this invention relates and are intended to be within the scope of the claims, which follow. It is noted, as is conventional, the use of a singular element in a claim is intended to cover one or more of such an element.

1. A connector assembly comprising:
a first connector having an insulative first housing and a first power contact located at least partially within the first housing;
a first signal contact located at least partially within the first housing;
a second connector having an insulative second housing with a second power contact located at least partially within the second housing, the second power contact configured to engage the first power contact upon mating between the first connector and the second connector;
a channel in the second housing; and
a signal module having a signal housing and a second signal contact located at least partially within the signal housing, the signal housing being slidably insertable in the channel, wherein the second signal contact mates with the first signal contact upon mating between the first connector and the second connector.

2. The connector assembly of claim 1, wherein the first power contact is one of a blade member and a pair of opposing members configured to receive the blade and the second power contact is the other of the blade member and the pair of opposing members configured to receive the blade.

3. The connector assembly of claim 1, wherein the first power contact comprises a first contact blade member and a second contact blade member, the first and second contact blade members each having a back portion, the back portion of the first contact blade member and the second contact blade member spaced apart from each other, wherein a tail extends from the back portion of at least one of the first and second contact blade member.

4. The connector assembly of claim 3, wherein the first and second contact blade members are uncoupled at their respective back portions and define a medial space between these back portions.

5. The connector assembly of claim 1, wherein the channel of the second connector housing is configured to have a portion of the signal housing pass through the channel to an orientation at which the second signal contact is substantially parallel to the second powwer contact.

6. The connector assembly of claim 1, wherein the channel includes a first guide member and the signal housing has a second guide member, the second guide member adapted to slidably engage the first guide member during insertion of the receptacle signal module into the channel.

7. The connector assembly of claim 6, wherein the first guide member is one of a projecting member and a recessed member and the second guide member is the other of the projecting member and the recessed member.

8. The connector assembly of claim 1, wherein the channel includes a portion with four sides to form a ring-like structure and the second housing further including a stand-off for engaging the signal housing during insertion of the signal housing into the ring-like structure, the stand-off adapted to limit insertion of the signal housing.

9. The connector assembly of claim 1, wherein the second housing includes a latch adapted to removably secure the second housing to the plug housing, the latch having at least one longitudinal rib.

10. The connector assembly of claim 1, wherein the second connector includes a terminal position assurance member configured to couple to the second housing and retain at least one of the signal housing and the second power contact.

11. The connector assembly of claim 10, wherein the terminal position assurance member is adapted to removably couple to the second housing.

12. The connector assembly of claim 10, wherein the terminal position assurance member is adapted to retain both the second power contact and the signal housing.

13. The connector assembly of claim 12, wherein the terminal position assurance member is adapted to extend into the channel so as to prevent the signal housing from being removed from the second housing.

14. The connector assembly of claim 12, wherein the second housing includes an aperture and the terminal position assurance member includes a lock rib, the lock rib adapted to be positioned in the aperture and prevent the second power contact from being removed from the second housing.

15. The connector assembly of claim 1, wherein the first housing comprises a first modular housing and a second modular housing, wherein the first modular housing supports the first power contact and the second modular housing supports the first signal contact.

16. The connector assembly of claim 15, wherein the first modular housing is configured to slidably mate with the second modular housing.

17. The connector assembly of claim 1, wherein one of the first connector and the second connector includes a plurality of tails adapted to mate with a board.

18. The connector assembly of claim 1, wherein the first connector is a plug connector and the first power and signal contacts are plug contacts, and wherein the second connector is a receptacle connector and the second power and signal contacts are receptacle contacts.

19. A connector with a signal module, the connector comprising:
an insulative housing;
a power contact located at least partially within the insulative housing;
a channel in the insulative housing; and
a signal module having a signal housing with a signal contact located at least partially within the signal housing, the signal housing being slidably insertable in the channel.

20. The connector of claim 19, wherein the channel includes a first guide member and the signal housing includes a second guide member adapted to slidably engage the first guide member when the signal housing is inserted in the channel.

21. The connector of claim 20, wherein the power contact is slidably insertable into the insulative housing.

22. The connector of claim 21, further comprising a terminal position assurance member configured to mount to the insulative housing and prevent the signal module and the power contact from being slidably removed from the insulative housing.

23. The connector of claim 22, wherein the insulative housing includes an aperture and the terminal position assurance member includes a lock rib that is configured to be positioned in the aperture so as to prevent the power contact from being slidably removed from the insulative housing.

24. The connector of claim 23, wherein the power contact is a first power contact and the connector includes a second power contact located at least partially within the insulative housing, the first and second power contacts positioned on opposite sides of the channel, wherein the terminal position assurance member is “T” shaped so as to limit removal of both the first and second power contacts as well as the signal module.

25. The connector of claim 19, further comprising a terminal position assurance member coupled to the insulative housing, the terminal position member configured to inhibit removal of at least one of the power contact and the signal module.

26. The connector of claim 25, wherein the terminal position assurance member is adapted to inhibit removal of both the signal module and the power contact from the insulative housing.

27. The connector of claim 19, wherein the power contact and the signal contact each include a contact tail adapted to mate with a board.

28. The connector of claim 19, wherein the power contact is configured to engage a power wire and the signal contact is configured to engage a signal wire.

29. The connector of claim 19, wherein the power contact is one of a first receptacle contact and a first plug contact and the signal contact is one of a second receptacle contact and a second plug contact.

30. A method for assembling a connector, comprising:
(a) providing an insulative housing with a power contact positioned in the insulative housing, the insulative housing including a channel;
(b) slidably inserting a signal module in the channel, the signal module including a signal housing with a signal contact positioned at least partly in the signal housing; and
(c) mounting a terminal position assurance member on the insulative housing, the terminal position assurance member preventing the power contact and the signal module from being removed from the insulative housing.

31. The method of claim 30, wherein (a) further comprises:
(i) providing the power contact; and
(ii) slidably inserting the power contact into a power passage of the insulative housing.

32. The method of claim 31, wherein (b) further comprises:
(i) engaging a first guide member on the signal housing with a second guide member in the channel so as to control insertion of the signal module in the channel; and
(ii) inserting the signal module in the channel until the signal housing engages a stand-off.

33. The method of claim 32, wherein the insulative housing includes an aperture and the terminal position assurance member includes a lock rib and the mounting in (c) comprises:
(i) engaging the signal housing with the terminal position assurance member; and
(ii) positioning the lock rib in the aperture, the lock rib configured to prevent the power contact from being slidably removed from the power passage.

34. The method of claim 30, wherein the channel comprises a ring-like structure and the inserting in (b) slides a portion of the signal module through and beyond the ring-like structure.
